(19) United States
(12) Patent Application Publication
(10) Pub. No.: US 2014/0149270 A1
(43) Pub. Date: May 29, 2014

(54) HVAC CONTROLLER WITH INTEGRATED METERING

(71) Applicants: Stuart Lombard, Toronto (CA); Craig Scott McIntyre, Toronto (CA); Seldon T. James, Toronto (CA); David A. Hamilton, Toronto (CA)

(72) Inventors: Stuart Lombard, Toronto (CA); Craig Scott McIntyre, Toronto (CA); Seldon T. James, Toronto (CA); David A. Hamilton, Toronto (CA)

(21) Appl. No.: 14/090,722

(22) Filed: Nov. 26, 2013

Related U.S. Application Data
(60) Provisional application No. 61/729,978, filed on Nov. 26, 2012.

(51) Int. Cl. G05D 23/19; G06Q 30/04

(52) U.S. Cl. CPC G05D 23/1917; G06Q 30/04
USPC 705/34; 700/276

(57) ABSTRACT

A controller for a private unit in a multi-unit building is provided. The controller operates the private unit's HVAC equipment, and includes a processor, output display, memory, and a RF module for communication. The controller is operable to receive temperature or flow values of a fluid passing through the HVAC equipment. Using the received temperature values of the fluid passing through the HVAC equipment, the controller calculates a measured value of HVAC usage of the HVAC equipment. The measured value can be in units of energy or in dollars.

### FIELD OF USE

The present invention relates to HVAC equipment. More specifically, the present invention relates to an HVAC controller having integrated metering capabilities.

### SUMMARY

According to an embodiment of the invention, there is provided a controller operating HVAC equipment in a premise, the controller having a processor, output display, memory, and a RF module for communication wherein
the controller is operable to receive at least one of temperature and flow values of a fluid passing through the HVAC equipment; and
using the received at least one of temperature and flow values of the fluid passing through the HVAC equipment calculate a measurement value of HVAC usage of the HVAC equipment.

### BRIEF DESCRIPTION OF THE DRAWINGS

Embodiments will now be described by way of example only, with reference to the following drawings in which:

FIG. 1 is a schematic illustrating a building with multiple private units, each private unit having HVAC controller controlling a ‘two pipe’ fan coil, having integrated metering and wireless communication to the Internet;

FIG. 1A is a schematic illustrating a building with multiple private units, each private unit having HVAC controller controlling a ‘two pipe’ fan coil, having integrated metering and wired communication to the Internet;

FIG. 1B is a schematic illustrating a building with multiple private units, each private unit having HVAC controller controlling a ‘four pipe’ fan coil, having integrated metering and wireless communication to the Internet;

FIG. 2 is a front plan view of the controller shown in FIG. 1;

FIG. 3 is a schematic illustrating an electronic architecture of the controller shown in FIG. 1;

FIG. 4 shows a scheduling program for the controller of FIGS. 1-3; and

FIGS. 5A to 5C show different screens of a Utilities program for the controller of FIGS. 1-3.

### DETAILED DESCRIPTION

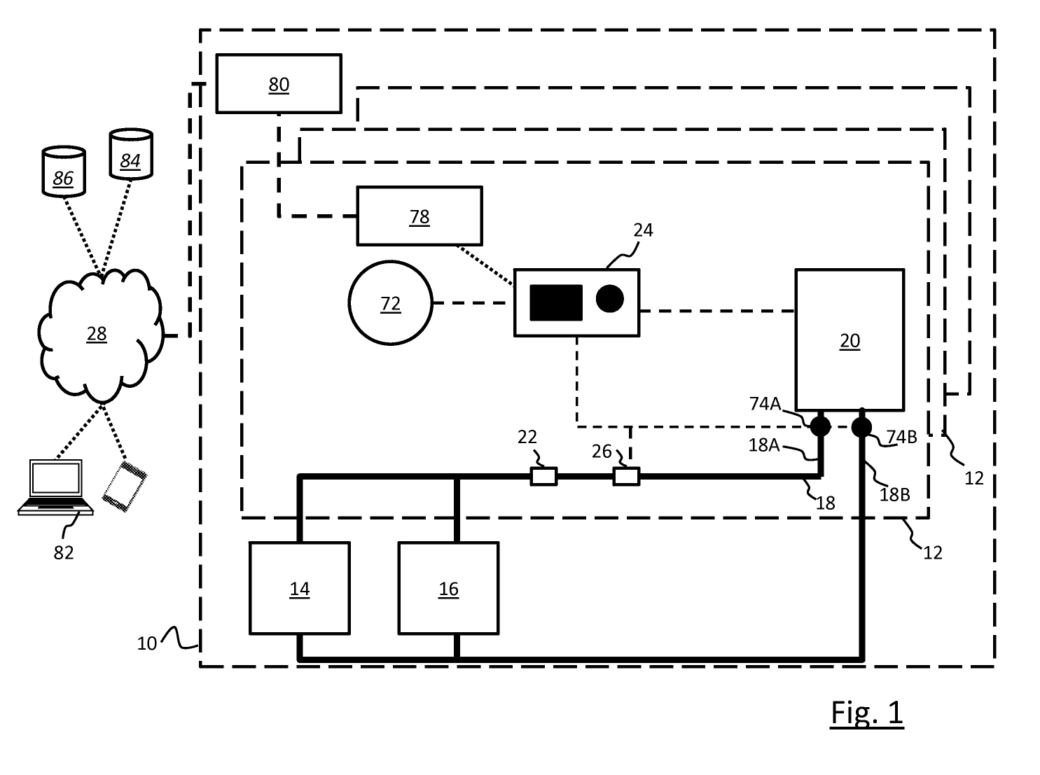

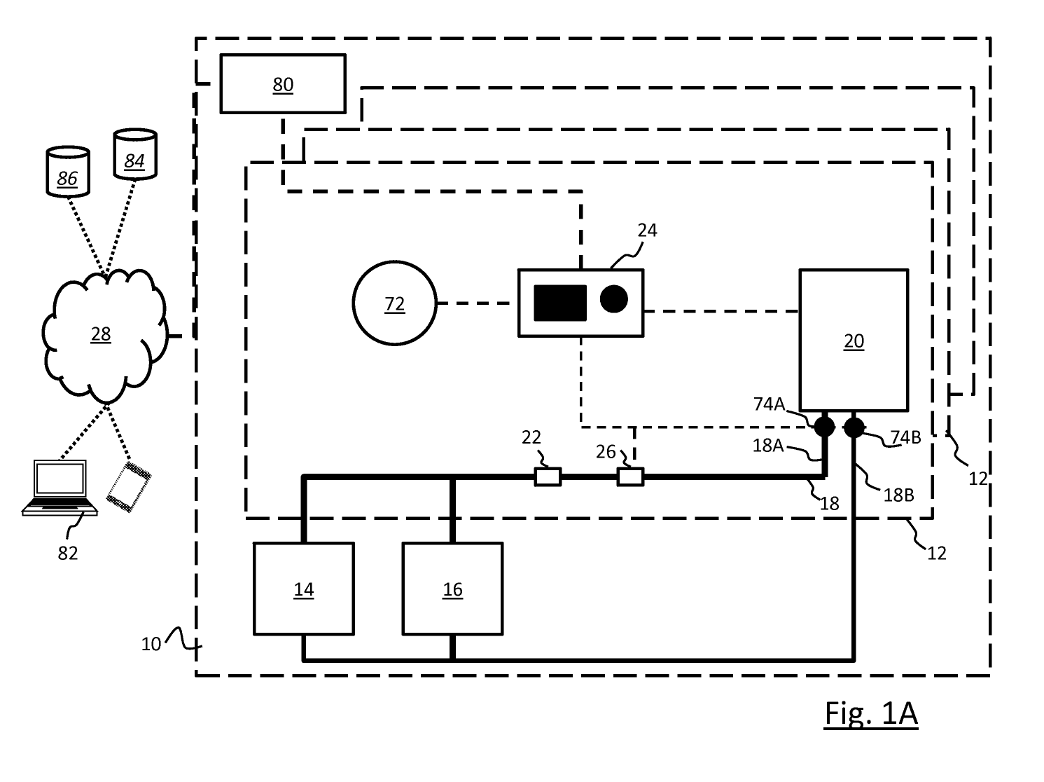

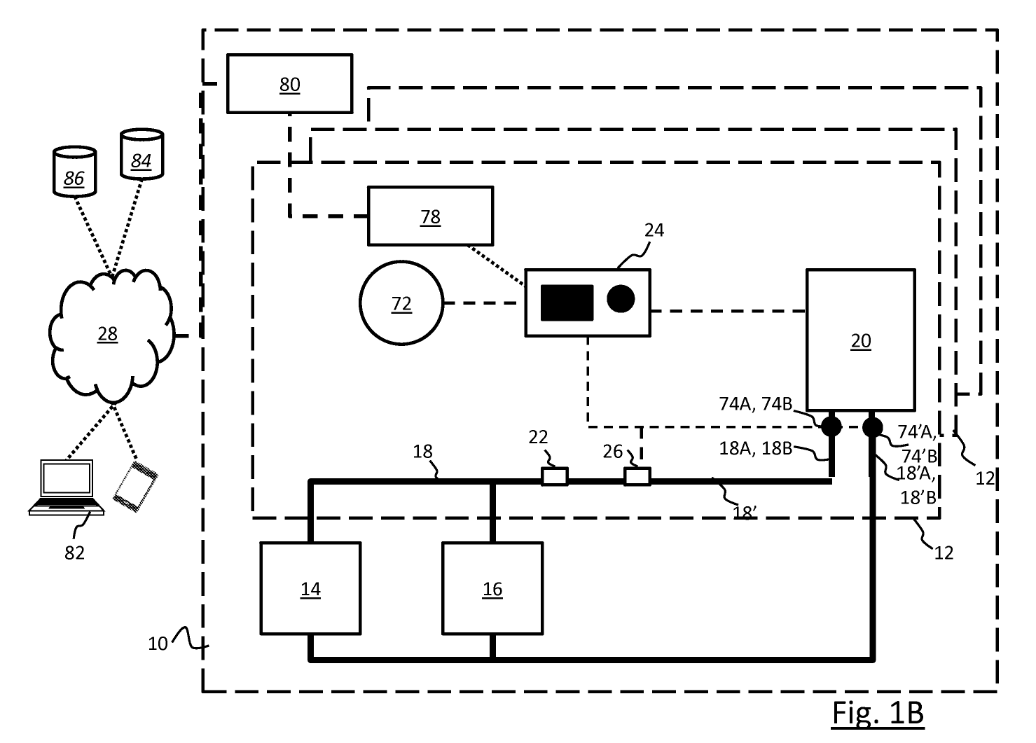

Referring now to FIG. 1, a multi-unit building is shown generally at 10. Building 10 is typically a multi-story structure that contains common areas as well as a plurality of private units 12 (alternatively referred to as premises). Private units 12 can include rental apartments as well as individually-owned condominiums.

Heating and cooling for building 10 is provided by a shared heating and cooling system. For the heating and cooling system in the presently-illustrated embodiment, heating is provided by one or more boilers 14, and cooling is provided by one or more chiller units 16. Boilers 14, of course, act to heat water or other fluid, and chiller units 16 act to cool the water or other fluid. Of course, depending on the geographical location of building 10, some buildings may have boilers 14, but not have chiller units 16, while others may have chiller units 16 but not boilers 14. In temperate regions, the majority of buildings 10 will have both boilers 14 and chiller units 16. In addition, building 10 may have other HVAC systems, such as ventilators and heat exchangers.

Fluid conduits 18 are provided to transport the heated fluid from boilers 14 or the cooled fluid from chiller units 16 to each private unit 12's separate HVAC equipment. In the presently-illustrated embodiment, the HVAC equipment provided for each private unit 12 is a fan coil 20, although other types of HVAC equipment such as heat pumps, radiators or other fluid-based heating/cooling equipment could be utilized. In the presently-illustrated embodiment, a ‘two-pipe’ system is used. As will be known to those of skill in the art, with a two-pipe system, fan coil is seasonally in fluid communication with the boiler 14 during the colder months of the year and is in fluid communication with the chiller units 16 during the warmer months of the year. Fluid conduit 18A is a ‘supply’ conduit, which brings heated or cooled fluid to the unit 12, and fluid conduit 18B is a ‘return’ conduit, which brings the fluid back to either the boiler 14 or the chiller unit 16. Optionally, one or more valves 22 may be provided either within fan coil 20 or along either or both of fluid conduits 18 to provide greater flow control between boiler 14 and/or chiller unit 16 and fan coil 20. (For the purposes of clarity of illustration, valves 22 are shown outside of fan coil 20). Valves 22 can include shut-off valves, diverting valves, mixing valves, or proportional valves. Also optionally, a flow sensor 26 is provided within either fan coil 20 or along at least one of the fluid conduits 18 to measure the amount of water that will be being passing through fan coil 20. (For the purposes of clarity of illustration, flow sensor 26 is shown outside of fan coil 20). In the presently-illustrated embodiment, flow sensor 26 is an ultrasonic, magnetic or jet-based flow sensor, and is operable to provide flow measurement values in terms of either volume or mass per unit time.

Temperature control for each private unit 12 is provided by a controller 24. Controller 24 is often colloquially referred to as a ‘smart thermostat’, but of course may also regulate HVAC functions other than temperature, such as humidification, dehumidification, ventilation and the like. In the presently-illustrated embodiment, controller 24 is connected to fan coil 20 using a 4-wire connection, although other wirings or even wireless connections could be used.

In addition to controlling fan coil 20, controller 24 is also operable to measure the runtime of fan coil 20 and receive error codes and other operating conditions from fan coil 20. Furthermore, as will be described in greater detail below, controller 24 is Internet-enabled, providing remote access and control.

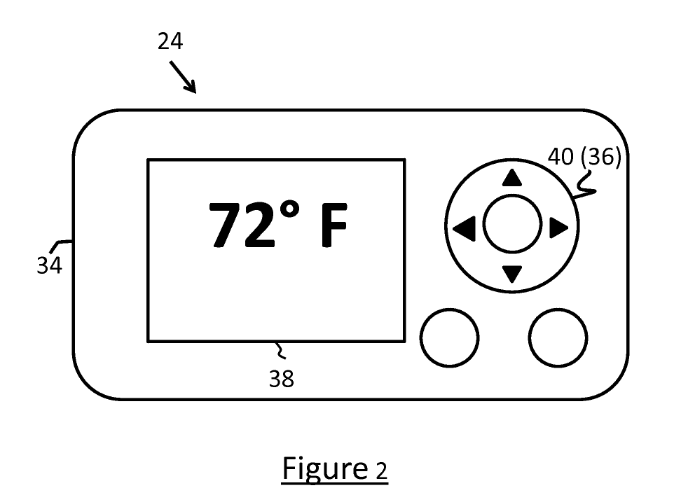

Referring now to FIG. 2, controller 24 is described in greater detail. Controller 24 includes a housing 34, which in the presently-illustrated embodiment, includes vents (not shown) to allow airflow within the housing. Controller 24 also includes at least one input 36 adapted to receive user commands and an output display 38 that is adapted for displaying environmental, operational, historical and programming information related to the operation of fan coil 20. Input 36 can include fixed-function hard keys, programmable soft-keys, or programmable touch-screen keys, or any combination thereof. Output display 38 can include any sort of display such as a LED or LCD screen, including segmented screens. In the currently-illustrated embodiment, the output display 38 is a colour LCD screen having varying levels of brightness. Of course, input 36 and output display 38 can be combined as a touch-screen display using capacitive sensing, resistive sensing, surface acoustic wave sensing, pressure sensing, optical sensing, and the like. In the presently-illustrated embodiment, controller 24 includes a 2.5″ TFT screen and uses a keypad 40 for input 36.

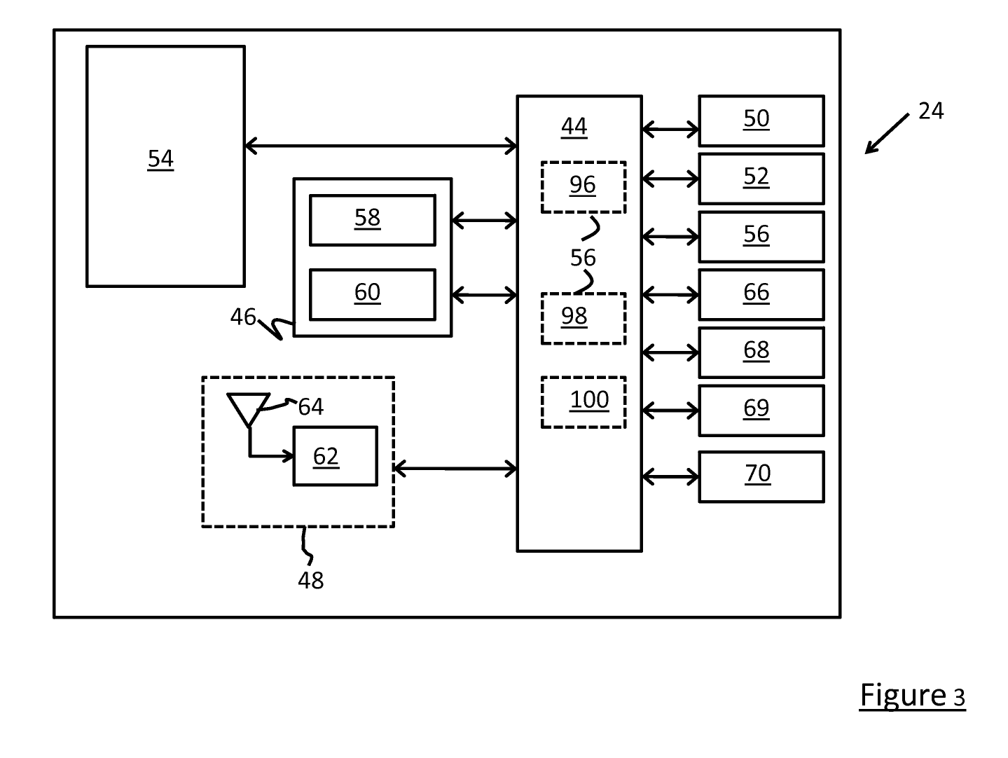

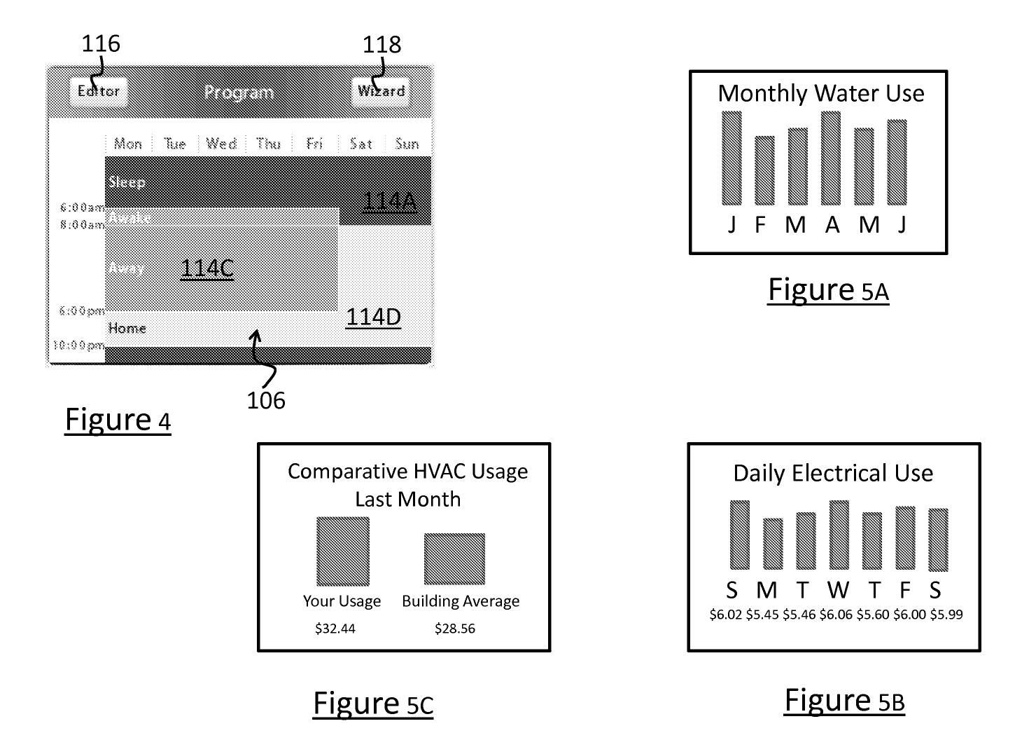

Referring now to FIG. 3, the internal components of controller 24 are shown in greater detail. In the presently-illustrated embodiment, controller 24 includes a processor 44, memory 46, a radio frequency (RF) subsystem 48, I/O interface 50, power source 52 and environmental sensor(s) 54.

Processor 44 is adapted to run various applications 56, many of which are displayed on output display 38 (FIG. 2) on controller 24. Details on applications 56 are provided in greater detail below. In presently-illustrated embodiment, processor 44 is a system on a chip (SOC) running on an ARM processor. Processor 44 can include additional integrated functionality such as integrating a touch-screen controller or other controller functions. Those of skill in the art will recognize that other processor types can be used for processor 44. Memory 46 includes both volatile memory storage 58 and non-volatile memory storage 60 and is used by processor 44 to run environmental programming (such as applications 56), communications and store operation and configuration data. In the presently-illustrated embodiment, the volatile memory storage 58 uses SDRAM and the non-volatile memory storage 60 uses flash memory. Stored data can include programming information for controller 24 as well as historical usage and metering data, as will be described in greater detail below. Other types of memory 46 and other uses for memory 46 will occur to those of skill in the art.

RF subsystem 48 includes a Wi-Fi chip 62 operably connected to a Wi-Fi antenna 64. In the presently-illustrated embodiment, Wi-Fi chip 62 support 802.11 b/g/n communication to a router within range that is connected to network 28. As currently-illustrated, Wi-Fi chip 62 supports encryption services such as WPA, WPA2 and WEP. Other networking protocols such as 802.11a or 802.16 (WiLan), as well as other encryption protocols are within the scope of the invention, RF subsystem 48 can further include other wireless communication subsystems and controllers, such as cellular communication subsystems, and/or home automation networks based upon Bluetooth networking, Zigbee networking, such as Zigbee Home Automation (HA) or Smart Energy (SE), ERT or IR networking. It is contemplated that RF subsystem 48 can include multiple radios, antennas and/or chipsets to support multiple protocols such as concurrent support of both Zigbee HA and Zigbee SE.

I/O interface 50 provides the physical connectors for controller 24. For example, I/O interface 50 may include the connectors for a 4-wire connection to fan coil 20. I/O interface can also include a debug port, a serial port, DB9 pin connector, a USB or microUSB port, Ethernet, RS 485 or coaxial connections, or other suitable connections that will occur to those of skill in the art. Power source 52 provides electrical power for the opera o of controller 24 and can include both wire-line power supplies and battery power supplies. In the presently-illustrated embodiment, the four-wire connection to I/O ports 50 can also provide the necessary power for controller 24, as well as any necessary surge protection or current limiters. Power source 52 can also include a battery-based back-up power system. In addition, power source 52 may provide a power connection jack which allows the controller 24 to be powered on without being connected to the 4 wire connection, or relying upon battery backup.

In addition, controller 24 can include one or more expansion slots or sockets 66. The expansion slot/socket 66 is adaptable to receive additional hardware modules to expand the capabilities of controller 24. Examples of additional hardware modules include memory expansion modules, remote sensor modules, home automation modules, smart meter modules, etc. The expansion slot/socket 66 could include an additional RF component such as a Zigbee® or Zwave™ module. The home automation module would allow capabilities such as remote control of floor diffusers, window blinds, etc. The combination of remote sensing and remote control would serve as an application for zoning temperature zone control.

Environmental sensor(s) 54 is adapted to provide temperature and humidity measurement values to the processor 44. In the presently-illustrated embodiment, environmental sensor 54 is an integrated component, but could also be separate thermistors and hydrometers. It is contemplated that environmental sensor 54 could include additional sensing capabilities such as carbon-monoxide, air pressure, smoke detectors or air flow sensors. Other sensing capabilities for environmental sensor 54 will occur to those of skill in the art. The environmental sensor 54 may be built near vents located near the “bottom” of housing 34 (relative to when controller 24 is mounted on a wall) so as to minimize the effects of waste heat generated by the hardware of controller 24 upon environmental sensor 54.

Controller 24 can include additional features, such as an audio subsystem 68. The audio subsystem 68 includes a speaker and/or microphone and can be used to generate audible alerts and input feedback. Depending on the desired features, audio subsystem 68 can be adapted to synthesize sounds or to play pre-recorded audio files stored in memory 46. Audio subsystem 68 may also provide intercom services for the private unit 12 within building 10. (If audio subsystem 68 is used to provide intercom services for the private unit 12, then output display 38 can be connected to building 10's CCTV system to provide video capabilities to complement the intercom services).

Another additional feature for controller 24 is a mechanical reset switch 69. In the presently-illustrated embodiment, mechanical reset switch 69 is a microswitch that when depressed either restarts the controller 24 or reinitializes the controller 24 back to its original factory condition.

Controller 24 further includes one or more sensor input/output(s) 70 (otherwise referred to as sensor IO 70), which is operable to communicate with one or more remote sensors (not shown) that are distributed around the inside and/or the outside of private unit 12. Remote sensors are operable to provide remote sensor measurement values for temperature, humidity, air flow, HVAC system monitoring (such as discharge and return air) and/or CO2. Multiple remote sensors inside are typically used to provide zone control, or averaged space temperature across multiple remote sensors. A remote sensor located outside the premise is used to provide weather information. Remote sensors can also be used to monitor non-HVAC devices such as fridges or freezers. Remote sensors can also include I/O modules that convert hardwired dry contact inputs to wireless signals that are sent back to controller 24, or conversely takes ON/OFF signals from the controller and transmits them wirelessly to this module. Inputs for these remote sensors can include flood sensors, door/window sensors, motion or other occupancy sensors, alarm system relays or KYZ pulse counter. Outputs for these remote sensors can include Occupancy switches for lighting systems, HVAC Economizers, other HVAC switches, non-plug form factor loads (pool pumps, water tanks), etc.

In the presently-illustrated embodiment, sensor IO 70 is connected to a water meter 72 (FIG. 1). Using sensor IO 70, controller 24 is operable to receive measurement values of potable water consumption within each private unit 12. (As is known to those of skill in the art, potable water consumption normally relies upon a separate water supply and set of conduits than the heating and cooling system for sanitary reasons). In the illustrated-embodiment, water meter 72 is connected to sensor IO 70 via a twisted pair cable, but of course, other cable or wireless connections could be used. Sensor IO 70 is also connected to flow sensor 26 to receive measurements of flow through fluid conduits 18. Optionally, sensor IO 70 is also connected to a private unit 12's electrical meter (via wired or wireless connection), to provide electricity usage measurements to controller 24.

Also in the presently-illustrated embodiment, sensor IO 70 is connected to a pair of temperature sensors 74A and 74B (FIG. 1). Using sensor IO 70, controller 24 is operable to receive from temperature sensors 74A and 74B temperature measurements for the fluid temperature within fluid conduits 18A and 18B, respectively. Alternatively, temperature sensors 74A and 74B could be located within fan coil 20, and measure temperature measurements from within the fan coil 20. As illustrated, temperature sensors 74A and 74B are paired 10 Kohm temperature sensors, but other types of temperature sensors could also be used.

As mentioned previously, controller 24 includes wireless capabilities (such as WiFi) through RF subsystem 48. Referring back to FIG. 1, using RF subsystem 48, controller 24 is Internet-enabled and can connect to network 28 (which can include both the public Internet and private Intranet) using WiFi router(s) 78 and Ethernet switch 80. By being connected to the network 28, controller 24 can be controlled by a remote device 82, which could be a personal computer, laptop or a mobile device such as smart phones, tablets or Personal Digital Assistants (PDAs). Controller 24, particularly when connected to the Internet, can provide climate control functionality beyond that of conventional thermostats through the running of applications on controller 24 and/or the running of applications on remote devices 82. Using a remote device 82, users can view measured temperature values within their private unit 12, control and program their fan coil 20, as well as view measurement data received through remote sensor IO 70. These functions will be described in greater detail below.

Referring now to FIG. 1A, an alternative embodiment is shown. In the embodiment illustrated in FIG. 1A, controller 24 includes an Ethernet jack (not shown) and is connected to Ethernet switch directly via an Ethernet cable instead of a wireless connection. Other networking configurations for controllers 24 within building 10 will occur to those of skill in the art.

As described above, controller 24 runs a plurality of applications. The main application is the environmental control program (ECP) 96. ECP 96 is operable to display and regulate environmental factors within a premise 12 such as temperature, humidity and fan control by transmitting control instructions to fan coil 20. ECP 96 displays the measured current temperature and the current temperature set point on output display 38. ECP 96 may also display the measured current humidity and/or humidity set point (not currently illustrated) In addition, ECP 96 maintains historical record data of set points and measured values for temperature and humidity. These can be stored locally in memory 46, or transmitted across network 28 for storage by a remote web server 84.

ECP 96 may be manipulated by a user in numerous ways including a 7 day Scheduling program 106, a Vacation Override program and manual temperature adjustment. The 7 day Scheduling program 106 allows the user to adjust set-points for different hours of the day that are typically organized into a number of different usage periods such as, but not limited to, “Awake” period 114A), “Away” (usage period 114B), “Home” (usage period 114C) and “Sleep” (usage period 114D). For most users, the usage periods 114 will be associated with their own personal behaviours. Thus, the Away period may have reduced cooling or heating as the users are at work/school, etc. Scheduling program 106 may include different programming modes such as an editor 116 and a wizard 118.

Configuration program 98 (alternatively called “Settings”) allows a use o configure many different aspects of their controller 24, including Wi-Fi settings, Reminders and Alerts, Installation Settings, display preferences, sound preferences, screen brightness and Password Protection. Users may also be able to adjust their own privacy settings, as well as configure details pertaining to their fan coil 20, such as the type and manufacture of the furnace, air conditioning and/or humidification system. In addition, users of Configuration program 98 may be able to specify certain physical and environmental parameters of their private unit 12, such as the size of premise 12, or the number of inhabitants of premise 12. Additionally, a user may be able to specify the type of construction and materials used for window panes, such as single or double paned, argon filled, etc. Given the comparatively homogonous construction of all the private units 12 within building 10, details pertaining to hardware, unit size and construction materials may be pre-populated by the builder or building management company. Other aspects of controller 24 that can be modified using the Configuration program 98 will occur to those of skill in the art.

Utilities program 100 (FIGS. 5A-5C) is a program that allows users to monitor and regulate their energy and water consumption Utilities program 100 can include a real-time display of received measurement values of energy and water use, regular reports (hourly, daily, weekly, etc.), and provide estimates of projected costs. As described earlier, controller 24 is adapted to receive and display received water measurement values from water meter 72. Using utilities program 100, a user can view their current and historical water usage for their private unit 12 over different time intervals, such as Daily, Weekly or Monthly periods (an example is shown in FIG. 5A). Monthly periods may coincide with calendar months or those of billing cycles. Utilities program may also be able to transmit the water usage data to remote web server 84 or to a billing server 86 (FIG. 1) operated by either building 10's property management company or an independent utility company. In addition, utilities program 100 may also be able to display the average water, energy, electricity, or other utility usage data for other private units 12 within building 10. This average water usage data would be aggregated and calculated at remote web server 84 or billing server 86 based upon the water consumption of all the private units 12 within building 10, and then transmitted to controller 24. Thus, an inhabitant of one of the private units 12 would be able to compare their water usage against that of their neighbours.

If controller 24 is also connected to a unit's electrical meter, either directly or by interface to an electrical meter database, then utilities program 100 is also able to display the unit's current and historical electrical consumption in different time intervals, such as Hourly, Daily, Weekly or Monthly periods (FIG. 5B). Monthly periods may coincide with calendar months or those of billing cycles. If building 10 is located in a jurisdiction with non-fixed electrical pricing (such as tiered electrical billing or TOU billing), electrical consumption should also be displayed in pricing tiers. Additionally, controller 24 can transmit measured electrical usage values in a similar fashion, as well as provide comparative electrical usage analysis. Utilities program 100 may also allow a user to configure how their fan coil 20 responds to different Demand-Response events issued by their utility. The energy use program 100 may require additional hardware components, such as a smart meter reader in expansion slot/socket 66, or a connection to a smart meter through sensor IO 70.

Utilities program 100 is also operable to measure and display heating and cooling energy use (“HVAC usage”) for the private unit 12. As described above, controller 24 receives measured temperature values from temperature sensors 74A and 74B via sensor IO 70. More specifically, controller 24 receives a T_{supply} value from fluid conduit 18A (o fluid conduit 18′A) and a Tᵣₑₜᵤᵣₙ value from fluid conduit 18B (or fluid conduit 18′B), and is able to determine heat loss or gain (ΔT) of the fluid as it passes through fan coil 20. Controller 24 is also operable to receive the measured volume (V) of fluid which passes through fluid conduit 18 by through measurements received from flow sensor 26. Since the heat capacity (C) of the fluid (such as water) within fluid conduit 18 (or fluid conduit 18′) is also known, using the measured volume of fluid passing through fan coil 20 and the ΔT value, it is possible for controller 24 to determine the energy being used to heat or cool the private unit 12 to the desired temperature setpoint (referred to informally as “HVAC usage”). The calculation of thermal energy and accuracy requirements of various components of the thermal meter system shall be in general compliance with EN-1434 (2006), CSA C900.1-06(R2011), or other heat metering standards as required by local jurisdictions. In absence of a local heat metering standard, CSA C900.1-06 or similar standard would be applicable.

It has been contemplated that controller 24 may be able to determine HVAC usage in other ways, for use in jurisdictions in which governing heat meter standards are not required. For example, if the flow of fluid through fluid conduit 18 is constant, then it is possible to remove the flow sensor 26 and still calculate the amount of energy being consumed by fan coil 20. Alternatively, in lieu of measuring the ΔT of the fluid in fluid conduits 18, the HVAC consumption of private unit 12 could be calculated using the measured runtime of fan coil 20. Other means of calculating the HVAC consumption of private unit 12 will occur to those of skill in the art.

Utility use program 100 can convert the measured energy consumption for each of its measured utilities (water usage, electrical usage, HVAC usage) into the preferred unit of energy or appropriate power measurement (such as BTU/h or kWh). As with water and electrical usage, current and historical HVAC usage can be displayed on controller 24 or on a remote device 82. HVAC usage can also be transmitted to a billing server 86 to provide utility billing for private unit 12. Furthermore, utilities program 100 can provide a comparison of HVAC usage between private units 12 to encourage energy conservation.

While HVAC usage can be presented in units of energy or power, it can also be presented in a derived value such as equivalent CO2 emissions or as a dollar value. When a is derived value is used, it is calculated by multiplying the actual consumption units with a unit cost value (whether the cost is in dollars or CO2 emissions). Different unit cost values can be used for fluid heated by boiler 14 or cooled by chiller unit 16. The derived value could also represent a composite value indicative of two or more measures of energy usage, and may vary dynamically in response to time-of-use utility pricing, or changes in CO2 emissions per unit energy supplied to the electrical grid within the utility's jurisdiction.

While utilities program 100 has been illustrated as running on controller 24 and being primarily displayed on the output display 38 of controller 24, it can also run and/or be displayed on a remote device 82. When run or displayed remotely, the utilities program 100ᵣₑₘₒₜₑ will generally provide similar functionality, but may be reformatted to account for the particular display, input and computing characteristics of the particular remote device 82. For example, a smart phone may have a touch screen instead of a keypad. It is also contemplated that utilities program 100ᵣₑₘₒₜₑ may have greater or reduced functionality in comparison to its counterpart running on controller 24.

Referring now to FIG. 1C, another alternative embodiment is shown. In this embodiment, a ‘four-pipe’ system is used. As will be known to those of skill in the art, with a four-pipe system, fan coil is in communication with both the boiler 14 and the chiller units 16, allowing for either heating or cooling to be provided at any time of the year (and also to allow for ‘Auto’ changeovers). Boiler 14 and chiller unit 16 are connected to fan coil 20 by separate fluid conduits 18 and 18′, respectively. Fluid conduit 18A is a ‘supply’ conduit and fluid conduit 18B is a ‘return’ conduit for boiler 14. Fluid conduit 18′A is a ‘supply’ conduit and fluid conduit 18′B is a ‘return’ conduit for chiller unit 16. Each of fluid conduits 18 and 18′ are equipped with their own flow sensors 26, 26′, valves 22, 22′, and temperature sensors 76A and 76B and 76′A and 76′B. However, the functioning of ECP 96 and utilities program 100 are substantially identical to that described above.

Although an HVAC Controller with integrated Metering as been used to establish a context for disclosure herein, it is contemplated as having wider applicability. Furthermore, the disclosure herein has been described with reference to specific embodiments; however, varying modifications thereof will be apparent to those skilled in the art without departing from the scope of the invention as defined by the appended claims.

What is claimed is:

1. A controller operating HVAC equipment in a premise, the controller having a processor, put display, memory, and a RF module for communication, wherein
the controller is operable to receive at least one of temperature and flow values of a fluid passing through the HVAC equipment; and
using the received at least one of temperature and flow values of the fluid passing through the HVAC equipment calculate a measurement value of HVAC usage of the HVAC equipment.

2. The controller of claim 1, wherein the controller is further operable to display the measurement of HVAC usage of the HVAC equipment on the output display.

3. The controller of claim 1, wherein the controller is further operable to transmit the calculated measurement value of HVAC usage to one of a billing server and a remote web server.

4. The controller of claim 1, wherein the controller is further operable to receive an average value of HVAC usage in comparable premises from one of a billing server and a remote web server, and comparatively display the average value of HVAC usage with the measurement value of HVAC usage on the output display.

5. The controller of claim 1, wherein the controller is further operable to receive measurement values indicative of other utility usage in the premise.

6. The controller of claim 1, wherein the controller is further operable to receive measurement values indicative of other utility usage in the premise, the other utility usage including at least one of water usage and electricity usage.

7. The controller of claim 1, wherein the controller is operable to calculate a measurement value of HVAC usage based upon a ΔT value of a fluid entering the HVAC equipment and then exiting the HVAC equipment.

8. The controller of claim 1, wherein the controller is operable to calculate a measurement value of HVAC usage based upon the runtime of the HVAC equipment.

9. The controller of claim 1, wherein the HVAC equipment is a fan coil.

10. The controller of claim 1, wherein the controller can display pricing information for the HVAC equipment, the pricing information.

11. The HVAC controller of claim 1, wherein the controller can transmit measurement values to a remote device via the Internet.
